(19) United States
(12) Patent Application Publication
(10) Pub. No.: US 2026/0248673 A1
(43) Pub. Date: Aug. 27, 2026

(54) PATIENT SUPPORT BOARD

(71) Applicant: LEO CANCER CARE, INC., Middleton, WI (US)

(72) Inventors: Andries N. Schreuder, Middleton, WI (US); Shane Ikner, Middleton, WI (US)

(21) Appl. No.: 19/161,361

(22) PCT Filed: Mar. 1, 2024
(86) PCT No.: PCT/US2024/017994

§ 371 Date: Sep. 2, 2025

Related U.S. Application Data
(60) Provisional application No. 63/449,657, filed on Mar. 3, 2023.

(51) Int. Cl. A61G 15/12; A61G 13/12

(52) U.S. Cl. CPC A61G 15/12; A61G 13/121; A61G 13/122; A61G 13/1235

(57) ABSTRACT

Provided herein is technology relating to radiological imaging and treatment and particularly, but not exclusively, to a patient support system configured to support a pediatric patient positioned in an upright position during medical imaging and/or during medical treatment and to related methods, kits, and systems.

### STATEMENT OF RELATED APPLICATIONS

This application claims the benefit of U.S. Provisional Patent Application No. 63/449,657, filed Mar. 3, 2023, the entire contents of which are incorporated herein by reference for all purposes.

### FIELD

Provided herein is technology relating to radiological imaging and treatment and particularly, but not exclusively, to a support board configured to support a patient (e.g., a pediatric patient) positioned in a generally upright position during medical imaging and/or during medical treatment and to related methods, kits, and systems.

### BACKGROUND

Radiation sources have many uses in medicine, including medical imaging and radiation therapy. Generally, radiation sources are configured to move in relation to a stationary patient, e.g., to expose a specific part or region of the patient to radiation produced by the source. Further, while radiation therapy and the associated diagnostic and planning imaging are conventionally performed with patients in prone or supine horizontal positions, some patients benefit from therapy while in an unconventional position, such as an upright position. The clinical benefits of upright imaging and radiotherapy treatments are numerous and are well documented. The first evidence of the important clinical benefits using the system to position real patients in a test setting was recently documented.

Patients under the age of 18 years are generally regarded as pediatric patients, and pediatric patients can be categorized as: (1) pediatric patients that are tall enough to fit the adult patient profile per the system design specifications, (2) smaller pediatric patients that do not require anesthesia and (3) pediatric patients that require anesthesia. There is a need to develop support assemblies that allow for pediatric patients to be treated in the upright orientation with their needs for anesthesia met.

### SUMMARY

Provided herein is technology relating to radiological imaging and treatment and particularly, but not exclusively, to a support board configured to support a front of a patient in an upright position during medical imaging and/or during medical treatment and to related methods, kits, and systems. Some technologies for supporting a patient in an upright, stable position are described in U.S. Pat. App. Pub. No. 2020/0268327 and is incorporated herein by reference.

In some embodiments, a patient positioning system stabilizes and supports a pediatric patent in an upright (e.g., standing, sitting, kneeling, perched) position. Imaging and/or treating patients in an upright position provides the benefits of increasing patient comfort. Further, diagnosis and/or treatment of patients in an upright position provides advantages over conventional diagnosis and/or treatment of patients in a horizontal position for many indications (e.g., lung cancer, breast cancer). While imaging and/or treating an upright patient provides diagnostic and therapeutic advantages, medical imaging and treatment needs improved patient positioning systems for stabilizing and supporting pediatric patients in a suitable upright position for delivering therapeutic radiation doses to target areas and for planning treatment using medical imaging. The technology provided herein relates to improved pediatric supports for a patient positioning system that supports a pediatric patient in an upright position.

In one aspect, the disclosure provides a patient support system comprising: a base defining a center axis, a seat portion coupled to the base, and a board coupled to the base.

The board includes a first surface facing towards the center axis and a second surface opposite the first surface. The first surface of the board is configured to engage a front of a patient.

In some embodiments, the board includes an aperture configured to receive at least a portion of a head of the patient.

In some embodiments, the aperture is positioned in an end portion of the board.

In some embodiments, the board includes a first wing portion configured to at least partially support a first arm of the patient (e.g., a left arm), and wherein the board includes a second wing portion configured to at least partially support a second arm of the patient (e.g., a right arm). In some embodiments, the wing portions support both arms.

In some embodiments, an angle is defined between the board and the center axis, and wherein the angle is within a range of 5 degrees to 45 degrees.

In some embodiments, the angle is adjustable.

In some embodiments, the first surface of the board has a first dimension in an end portion, and a second dimension in a narrow portion, the second dimension smaller than the first dimension.

In some embodiments, the end portion includes an aperture.

In some embodiments, the first surface of the board has a third dimension in a flared portion, the third dimension larger than the first dimension.

In some embodiments, the narrow portion is positioned between the end portion and the flared portion.

In some embodiments, the base is rotatable about the center axis.

In some embodiments, the base is movable along the center axis.

In some embodiments, the center axis is vertical.

In some embodiments, the system further comprises a vacuum-formed bag.

In some embodiments, the vacuum-formed bag is positioned on the seat portion.

In some embodiments, the system further comprises a shell coupled to the board and configured to support a lower back of a patient.

In some embodiments, the system further comprises an attention capturing component.

In some embodiments, the attention capturing component is a video display.

In some embodiments, the attention capturing component is a toy (e.g., a fidget spinner).

In some embodiments, the patient is less than 60 inches tall.

In one aspect, the disclosure provides a heel booster including a bottom surface including a notch configured to at least partially receive a heel support of an upright patient positioning system. The heel booster further includes an elevated platform, a heel stop extending from the elevated platform, and a roller extending from the bottom surface.

In one aspect, the disclosure provides a patient support system comprising: a base defining a center axis; a pedestal coupled to the base; and a support pivotably coupled to the pedestal about a pivot axis. The support includes a lower portion, an upper portion, and an arcuate connection portion between the lower portion and the upper portion.

In some embodiments, the pivot axis is orthogonal to the center axis.

In some embodiments, the support further includes a head portion extending from the upper portion and configured to support a head of a patient.

In some embodiments, the system further including a shin stop coupled to the lower portion and configured to support a shin of a patient.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet; and/or a cellular network).

Embodiments of the technology may also relate to an apparatus for performing the operations herein. This apparatus may be specially constructed for the required purposes and/or it may comprise a general purpose computing device selectively activated or reconfigured by a computer program stored in the computer. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present technology will become better understood with regard to the following drawings.

FIG. 1 is a schematic of design considerations for an upright patient positioner to treat lesions superior to the upper thigh. The smaller person represents the size of 5% Japanese female, and the larger person represents the size of the 95% American male.

FIG. 2 is a photo of a booster seat that is used to fit a patient onto an upright patient positioning system.

FIG. 3 is a schematic of a heel booster that is used to make an upright patient positioning system compatible with a shorter patient.

FIG. 4 is a concept design of a backward leaning patient immobilization device. Panel A illustrates an upright patient positioning system with a standard backrest inserted. Panel B illustrates a backward leaning patient immobilization device inserted into the backrest slots and tilted into an upright position. Panel C illustrates a patient loaded into the backward leaning patient immobilization device and tilted into a supine position. Panel D illustrates the patients in an imaging position.

FIG. 5 is a concept design of a forward rest patient board. Panel A shows the upright patient positioning system with a standard backrest inserted. Panel B illustrates the forward rest patient board. Panel C illustrates the upright patient positioning system with a patient leaning into the forward rest patient board.

FIG. 6 is a perspective view of an imaging system, a therapy system, and the upright patient positioning system with the forward rest patient board.

FIG. 7A is a perspective view of the systems of FIG. 6, showing the imaging system in an angled configuration.

FIG. 7B is a perspective view of the systems of FIG. 6, showing the therapy system in a treating position.

FIG. 7C is a perspective view of the system of FIG. 6, showing the therapy system in a treating position and the patient support system in a lowered positioned.

FIG. 7D is a perspective view of the system of FIG. 6, showing the therapy system in a treating position and the patient support system in a lowered and rotated positioned.

FIG. 7E is a perspective view of the system of FIG. 6, showing the therapy system in a treating position and the patient support system in another lowered and rotated positioned.

FIG. 8 is a front view of a forward rest patient board.

FIG. 9 is a perspective view of a test fixture including the forward rest patient board of FIG. 8.

FIG. 10 is a photograph of the test fixture of FIG. 9.

FIG. 11 is a schematic of the test fixture of FIG. 9 illustrating connection of a face mask, a body shell, and a vacuum-formed bag.

FIG. 12 is a photograph of example patients.

FIG. 13 is a series of photograph of the example patients of FIG. 12 supported in the test fixture of FIG. 10.

FIG. 14 is another series of photographs of the example patients of FIG. 12 supported in the test fixture of FIG. 10.

FIG. 15 is a schematic showing a body shell supporting a patient in the test fixture of FIG. 10.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to radiological imaging and treatment and particularly, but not exclusively, to a support board configured to support a front of a patient positioned in an upright position during medical imaging and/or during medical treatment and to related methods, kits, and systems.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention is readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges. As used herein, the disclosure of numeric ranges includes the endpoints and each intervening number therebetween with the same degree of precision. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

As used herein, the suffix “-free” refers to an embodiment of the technology that omits the feature of the base root of the word to which “-free” is appended. That is, the term “X-free” as used herein means “without X”, where X is a feature of the technology omitted in the “X. free” technology. For example, a “calcium free” composition does not comprise calcium, a “mixing free” method does not comprise a mixing step, etc.

Although the terms “first”, “second”, “third”, etc. is used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., component, action, element). For example, when an entity is said to be “present”, it means the level or amount of this entity is above a pre determined threshold; conversely, when an entity is said to be “absent”, it means the level or amount of this entity is below a pre determined threshold. The pre determined threshold is the threshold for detectability associated with the particular test used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language is a compiled or interpreted language, and combined with hardware implementations.

As used herein, the term “computed tomography” is abbreviated “CT” and refers both to tomographic and non-tomographic radiography. For instance, the term “CT” refers to numerous forms of CT, including but not limited to X-ray CT, positron emission tomography (PET), single-photon emission computed tomography (SPECT), and photon counting computed tomography. Generally, computed tomography (CT) comprises use of an X-ray source and a detector that rotates around a patient and subsequent reconstruction of images into different planes. In embodiments of CT (e.g., devices, apparatuses, and methods provided for CT) described herein, the X-ray source is a static source and the patient is rotated with respect to the static source. Currents for X-rays used in CT describe the current flow from a cathode to an anode and are typically measured in milliamperes (mA).

As used herein, the term “structured to [verb]” means that the identified element or assembly has a structure that is shaped, sized, disposed, coupled, and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb.

As used herein, the term “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, the term “coupled” refers to two or more components that are secured, by any suitable means, together. Accordingly, in some embodiments, the statement that two or more parts or components are “coupled” shall mean that the parts are joined or operate together either directly or indirectly, e.g., through one or more intermediate parts or components. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the term “removably coupled” or “temporarily coupled” means that one component is coupled with another component in an essentially temporary manner.

That is, the two components are coupled in such a way that the joining or separation of the components is easy and does not damage the components. Accordingly, “removably coupled” components is readily uncoupled and recoupled without damage to the components.

As used herein, the term “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element is “operatively coupled” to another without the opposite being true.

As used herein, the term “rotatably coupled” refers to two or more components that are coupled in a manner such that at least one of the components is rotatable with respect to the other.

As used herein, the term “translatably coupled” refers to two or more components that are coupled in a manner such that at least one of the components is translatable with respect to the other.

As used herein, the term “temporarily disposed” means that a first element or assembly is resting on a second element or assembly in a manner that allows the first element/assembly to be moved without having to decouple or otherwise manipulate the first element. For example, a book simply resting on a table, e.g., the book is not glued or fastened to the table, is “temporarily disposed” on the table.

As used herein, the term “correspond” indicates that two structural components are sized and shaped to be similar to each other and is coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, a “path of travel” or “path,” when used in association with an element that moves, includes the space an element moves through when in motion. As such, any element that moves inherently has a “path of travel” or “path.” As used herein, the statement that two or more parts or components “engage” one another shall mean that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to clement A first position, element A engages element B,” and “when element A is in element A first position, element A engages element B” are equivalent statements and mean that element A either engages element B while moving to element A first position and/or element A either engages element B while in element A first position.

As used herein, the term “operatively engage” means “engage and move.” That is, “operatively engage” when used in relation to a first component that is structured to move a movable or rotatable second component means that the first component applies a force sufficient to cause the second component to move. For example, a screwdriver is placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the term “number” shall mean one or an integer greater than one (e.g., a plurality).

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center. That is, generally, for a cylindrical soup can, the “radial side/surface” is the generally circular sidewall and the “axial side(s)/surface(s)” are the top and bottom of the soup can.

As used herein, a “diagnostic” test includes the detection or identification of a disease state or condition of a subject, determining the likelihood that a subject will contract a given disease or condition, determining the likelihood that a subject with a disease or condition will respond to therapy, determining the prognosis of a subject with a disease or condition (or its likely progression or regression), and determining the effect of a treatment on a subject with a disease or condition. For example, a diagnostic can be used for detecting the presence or likelihood of a subject having a cancer or the likelihood that such a subject will respond favorably to a compound (e.g., a pharmaceutical, e.g., a drug) or other treatment.

As used herein, the term “condition” refers generally to a disease, malady, injury, event, or change in health status.

As used herein, the term “treating” or “treatment” with respect to a condition refers to preventing the condition, slowing the onset or rate of development of the condition, reducing the risk of developing the condition, preventing or delaying the development of symptoms associated with the condition, reducing or ending symptoms associated with the condition, generating a complete or partial regression of the condition, or some combination thereof. In some embodiments, “treatment” comprises exposing a patient or a portion thereof (e.g., a tissue, organ, body part, or other localize region of a patient body) to radiation (e.g., electromagnetic radiation, ionizing radiation).

As used herein, the term “beam” refers to a stream of radiation (e.g., electromagnetic wave and/or or particle radiation). In some embodiments, the beam is produced by a source and is restricted to a small-solid angle. In some embodiments, the beam is collimated. In some embodiments, the beam is generally unidirectional. In some embodiments, the beam is divergent.

As used herein, the term “patient” or “subject” refers to a mammalian animal that is identified and/or selected for imaging and/or treatment with radiation. Accordingly, in some embodiments, a patient or subject is contacted with a beam of radiation, e.g., a primary beam produced by a radiation source. In some embodiments, the patient or subject is a human. In some embodiments, the patient or subject is a veterinary or farm animal, a domestic animal or pet, or animal used for clinical research. In some embodiments, the subject or patient has cancer and/or the subject or patient has either been recognized as having or at risk of having cancer.

As used herein, the term “treatment volume” or “imaging volume” refers to the volume (e.g., tissue) of a patient that is selected for imaging and/or treatment with radiation. For example, in some embodiments, the “treatment volume” or “imaging volume” comprises a tumor in a cancer patient. As used herein, the term “healthy tissue” refers to the volume (e.g., tissue) of a patient that is not and/or does not comprise the treatment volume. In some embodiments, the imaging volume is larger than the treatment volume and comprises the treatment volume.

As used herein, the term “radiation source” or “source” refers to an apparatus that produces radiation (e.g., ionizing radiation) in the form of photons (e.g., described as particles or waves). In some embodiments, a radiation source is a linear accelerator (“linac”) that produces x rays or electrons to treat a cancer patient by contacting a tumor with the x-ray or electron beam. In some embodiments, the source produces particles (e.g., photons, electrons, neutrons, hadrons, ions (e.g., protons, carbon ions, other heavy ions)). In some embodiments, the source produces electromagnetic waves (e.g., x-rays and gamma rays having a wavelength in the range of approximately 1 pm to approximately 1 nm). While it is understood that radiation can be described as having both wave-like and particle-like aspects, it is sometimes convenient to refer to radiation in terms of waves and sometimes convenient to refer to radiation in terms of particles. Accordingly, both descriptions are used throughout without limiting the technology and with an understanding that the laws of quantum mechanics provide that every particle or quantum entity is described as either a particle or a wave.

As used herein, the term “static source” refers to a source that does not revolve around a patient during use of the source for imaging or therapy. In particular, a “static source” remains fixed with respect to an axis passing through the patient while the patient is being imaged or treated. While the patient may rotate around said axis to produce relative motion between the static source and rotating patient that is equivalent to the relative motion of a source revolving around a static patient, a static source does not move with reference to a third object, frame of reference (e.g., a treatment room in which a patient is positioned), or patient axis of rotation during imaging or treatment, while the patient is rotated with respect to said third object, said frame of reference (e.g., said treatment room in which said patient is positioned), or patient axis of rotation through the patient during imaging or treatment. Thus, a static source is installed on a mobile platform and thus the static source may move with respect to the Earth and fixtures on the Earth as the mobile platform moves to transport the static source. Thus, the term “static source” may refer to a mobile “static source” provided that the mobile “static source” does not revolve around an axis of rotation through the patient during imaging or treatment of the patient. Further, the static source may translate and/or revolve around the patient to position the static source prior to imaging or treatment of the patient or after imaging or treatment of the patient. Thus, the term “static source” may refer to a source that translates or revolves around the patient in non imaging and non-treatment use, e.g., to position the source relative to the patient when the patient is not being imaged and/or treated. In some embodiments, the “static source” is a photon source and thus is referred to as a “static photon source”.

Some of the embodiments herein refer to a patient support assembly configured with respect to patients with height according to a 95^{th} percentile American man and a 5^{th} percentile Japanese woman. It is to be understood that this is a preferred embodiment suitable for use with a wide range of patient populations, and that patient support assembly configured to receive patients of a different range of heights is equally permissible. A female Japanese patient of the 5^{th} height percentile is about 1490 mm. A male American patient of the 95^{th} height percentile is about 1900 mm.

In some embodiments, the patient support assembly provides a patient in a “perched position”. As used herein, the term “perched position” refers to a patient in a generally standing position with a torso angled posteriorly with respect to a vertical axis, optionally also having bent knees.

### Description

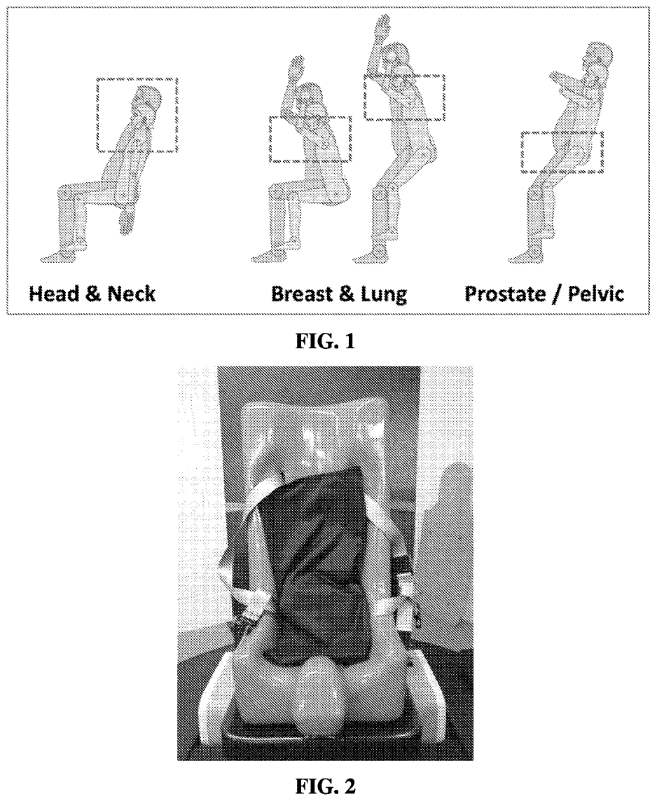

An upright patient positioning system (UPPS) is designed to position patients within a range of heights (lengths) including patients with height according to a 95^{th} percentile American man and a 5^{th} percentile Japanese woman. Such an upright patient positioning system is detailed in U.S. Patent Application Publication No. 2020/0268327 (U.S. application Ser. No. 16/649,337) and is incorporated herein by reference in its entirety. With reference to FIG. 1, patients ranging between these lengths can be positioned for imaging and treatment in the seated or upright positions without requiring additional or special immobilization and support devices.

A first category of pediatric patients includes those young patients that are as tall or taller than the 5^{th} percentile Japanese woman and can be positioned in the standard or as designed manner. In some embodiments, there will be conditions related to patient maturity and or medical conditions where pediatric patients in this first category may require additional means or special procedures to enable treatments. It is also generally accepted or assumed that patients that fall in this first category are old enough to cooperate with the treatment requirements without being sedated or anesthetized.

The second category of pediatric patients are patients that are shorter than the 5% Japanese female and can go through the treatment process without the need to be sedated or anesthetized. These pediatric patients may not fit comfortably in the standard upright patient positioning system and may require additional immobilization devices or booster apparatus to make them fit. As detailed herein, patients in this second category are positioned in two ways: (1) leaning backward in a seated or perched position or orientation for pelvic, thoracic, head, neck, and intracranial targets; and (2) leaning forward for posterior lesions and in particular craniospinal irradiation (CSI) treatments. Support devices for each way are detailed herein.

Leaning backwards: In some embodiments, a booster seat or specially designed support system is coupled to the standard backrest of the upright patient positioning system. One example of a commercially available booster seat is shown in FIG. 2. See, for example a Special Tomato ® Soft-Touch ® Floor Sitter with Wedge (https://www.adaptivemall.com/special-tomato-soft-touch.floor-sitter.html).

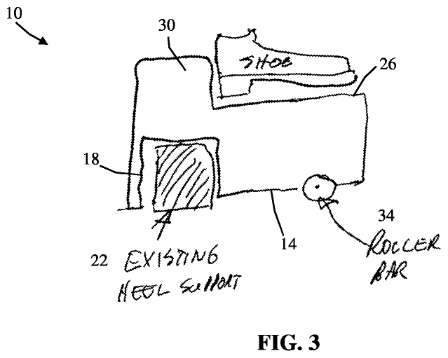

With reference to FIG. 3, in some embodiments, the positioning system includes a heel booster 10 that can be used to raise the floor level higher to compensate for shorter legs and still make the standard knee support and work. In the illustrated embodiment, the heel booster 10 includes a bottom surface 14 including a notch 18 that at least partially receives an existing heel support 22 of the upright patient positioning system. The heel booster 10 further includes an elevated platform 26 positioned above the existing heel stop 22, and an elevated heel stop 30 extending from the elevated platform 26. The heel booster 10 further includes a roller 34 (e.g., a roller bar) extending from the bottom surface 14 and configured to assist with moving the heel booster 10 with respect to the existing heel support 22.

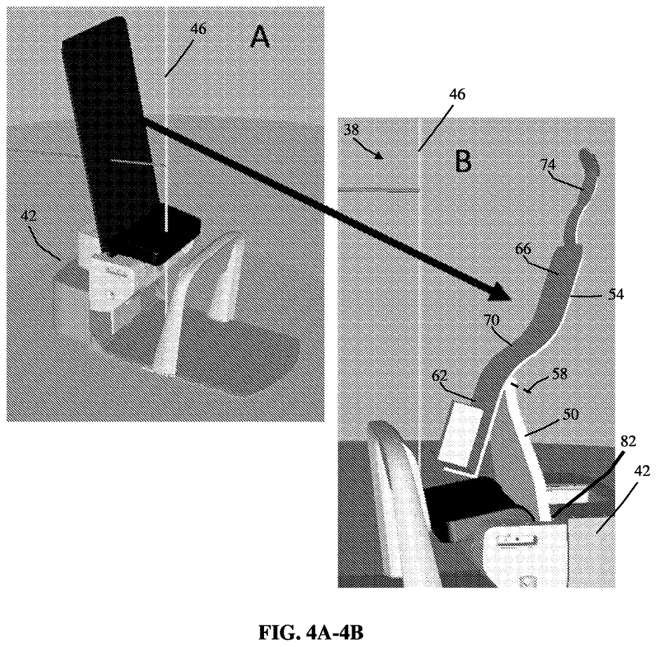

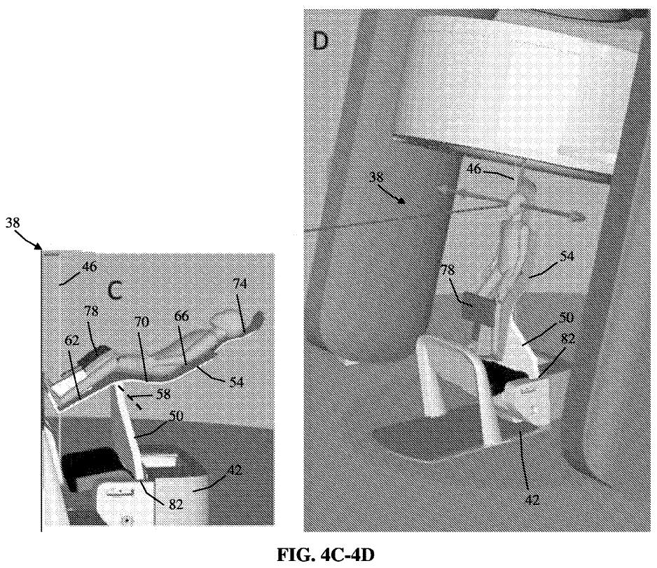

With reference to FIG. 4, a concept design of a backwards leaning patient support device is illustrated. Panel A illustrates the upright patient support system with a standard backrest inserted. Panel B illustrated pediatric-specific device inserted into the backrest slots and tilted into the upright position. The patient support system 38 includes a base 42 defining a center axis 46, a pedestal 50 coupled to the base 42 (e.g., inserted into the backrest slots), and a support 54 (e.g., a support board) pivotably coupled to the pedestal 50 about a pivot axis 58. Panel C shows a patients loaded into the system 38 and tilted in to a supine position. Panel D shows a patient loaded into the system 38 and positioned in an imaging position.

In some embodiments, the support 54 is car seat shaped, which children are accustomed and familiar with. The support 54 includes a lower portion 62, an upper portion 66, and an arcuate connection portion 70 between the lower portion 62 and the upper portion 66. In the illustrated embodiment, the support 54 further includes a head portion 74 extending from the upper portion 66. The head portion 74 is configured to support the back of a head of a patient. In the illustrated embodiment, a shin stop 78 is coupled to the lower portion 62 and is configured to support a shin of a patient.

In the illustrated embodiment, the pivot axis 58 is orthogonal to the center axis 46. In the illustrated embodiment, the pivot axis 58 is positioned behind the patient such that the patient can be tilted backwards (FIG. 4C) into a supine position. For example, a supine position might be required make certain medical procedures (e.g., applying immobilization devices, administering anesthesia, inserting intravenous tubes) easier and safer.

In some embodiments, the pedestal 50 and the support 54 are radio translucent. In some embodiments, the support 54 and/or the pedestal 50 are portable and removable from the base 42. In the illustrated embodiment, the pedestal 50 attaches and detaches from backrest slots 82 formed in the base 42. Advantageously, a portable patient support allows for easy ingress and egress of the patient to and from the treatment room. For example, the patient may be carried into and out of the room while in or on the support 54.

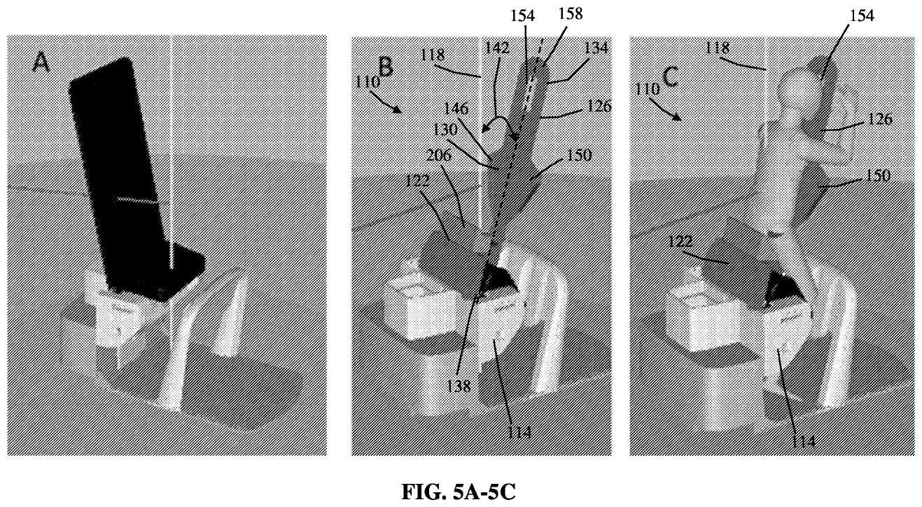

Leaning Forward: With reference to FIG. 5, a patient support system 110 is illustrated for supporting a patient in a leaning forward posture. This posture is useful for craniospinal irradiation (CSI) treatment, for example. The system 110 includes a base 114 defining a center axis 118 and a seat portion 122 coupled to the base 114. The system 110 further includes a board 126 (also referred to herein as a forward-rest or a support board) coupled to the base 114. Panel A of FIG. 5 illustrates the upright patient positioning system with a standard backrest inserted. Panel B of FIG. 5 illustrates the board 126 (e.g., forward-rest). Panel C of FIG. 5 illustrates a patient leaning forward into the board 126.

The board 126 includes a first surface 130 facing towards the center axis 118 and a second surface 134 positioned opposite the first surface 130. As detailed further herein, the first surface 130 of the board 126 is configured to engage and support a front of a patient.

In some embodiments, the board 126 is inserted into backrest slots 138 of the base 114 of the upright patient positioning system. In the illustrated embodiment, an angle 142 (FIG. 5B) is defined between the board 126 and the center axis 118. In some embodiments, the angle 142 is within a range of approximately 5 degrees to approximately 45 degrees. In some embodiments, the angle 142 is adjustable.

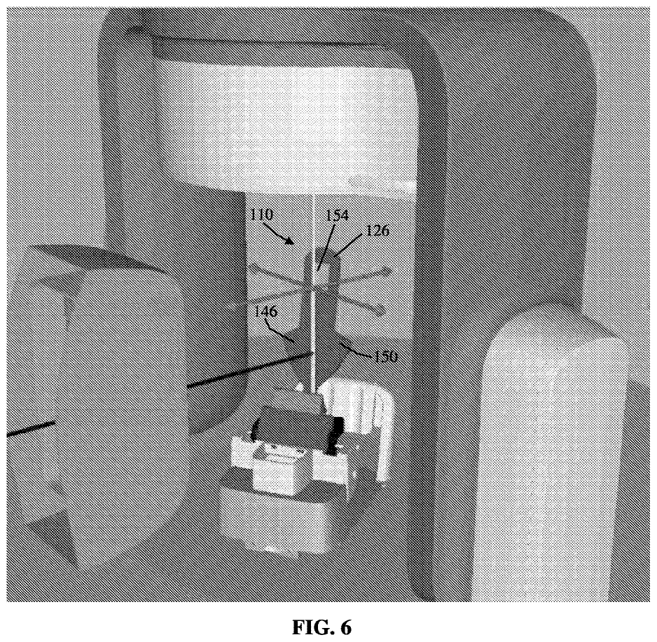

With reference to FIG. 6, the system 110 is shown with an imaging system. The board 126 includes a first wing portion 146 configured to at least partially support one arm of the patient and a second wing portion 150 configured to at least partially support another arm of the patient.

In the illustrated embodiment, the board 126 includes an aperture 154 configured to receive at least a portion of the patient's head. In some embodiments, the aperture 154 is positioned in an end portion 158 of the board 126.

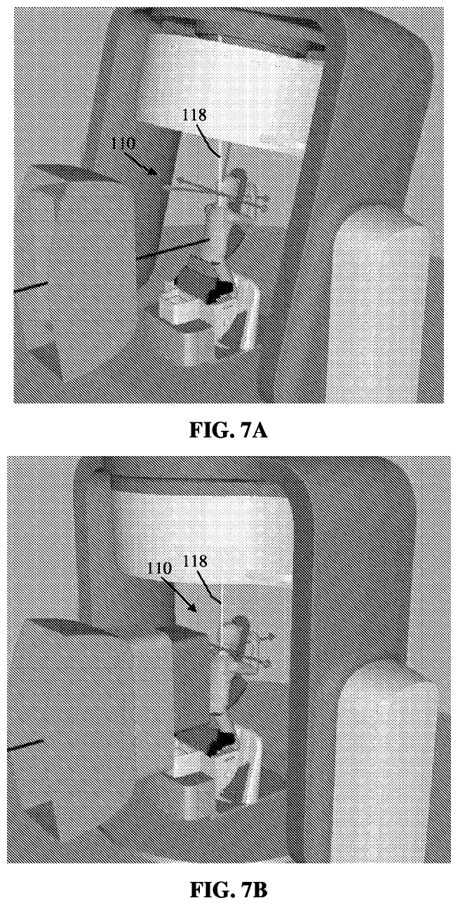

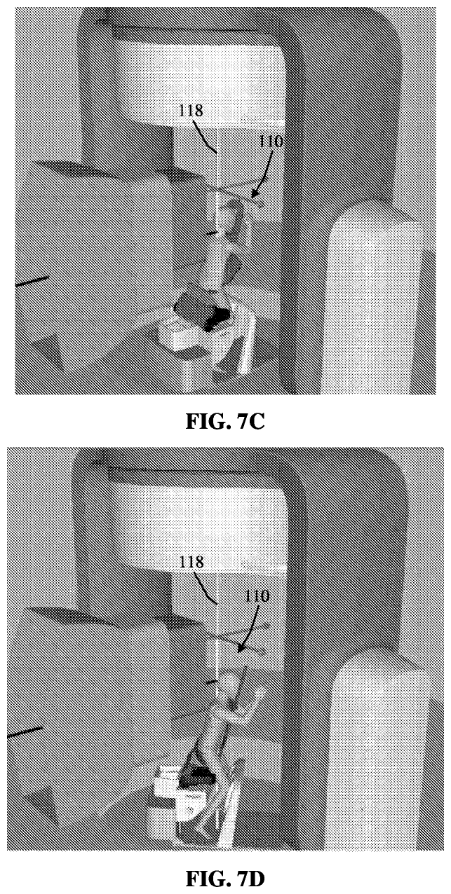

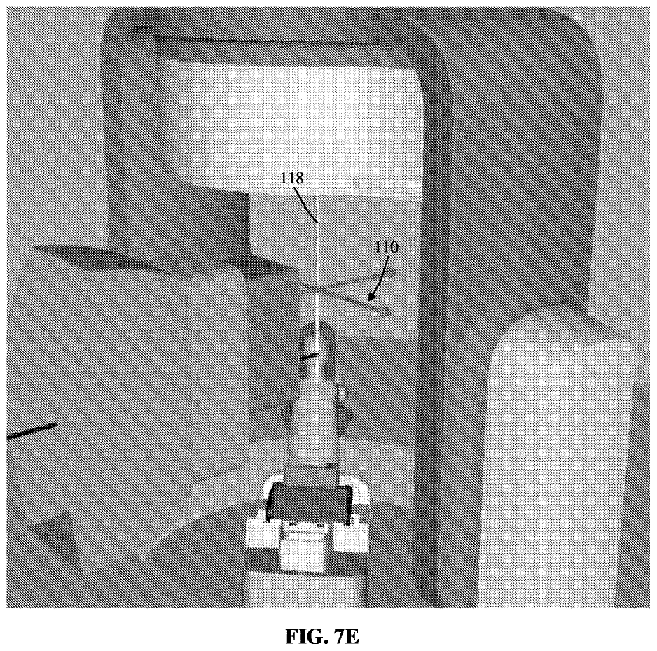

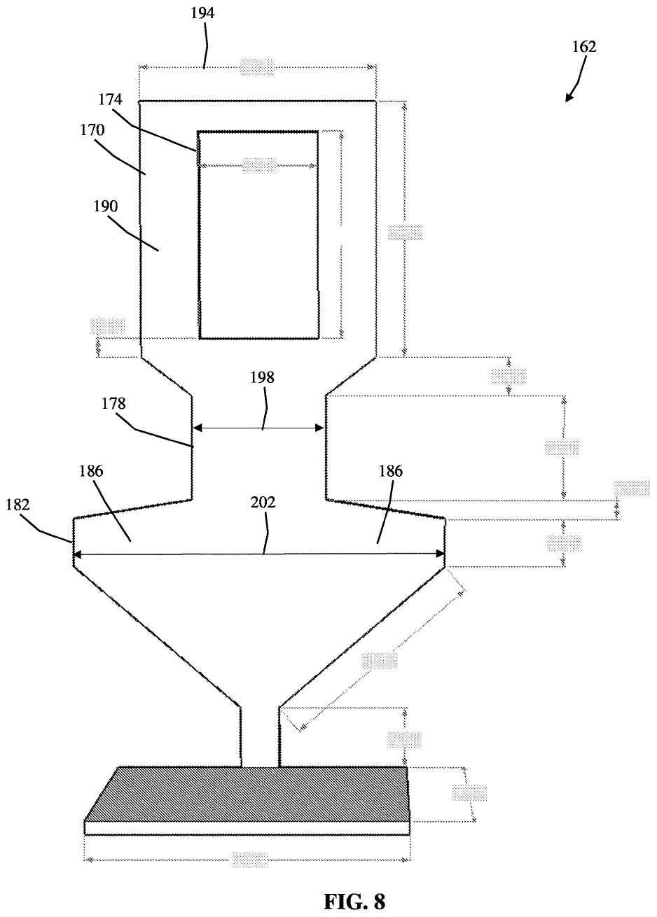

With reference to FIGS. 7A-7E, the patient and the patient support system 110 is shown in various imaging and treatment configurations. As illustrated, the base 114 is rotatable about the center axis 118 and the base 114 is movable along the center axis 118. In the illustrated embodiment, the center axis 118 is vertical.

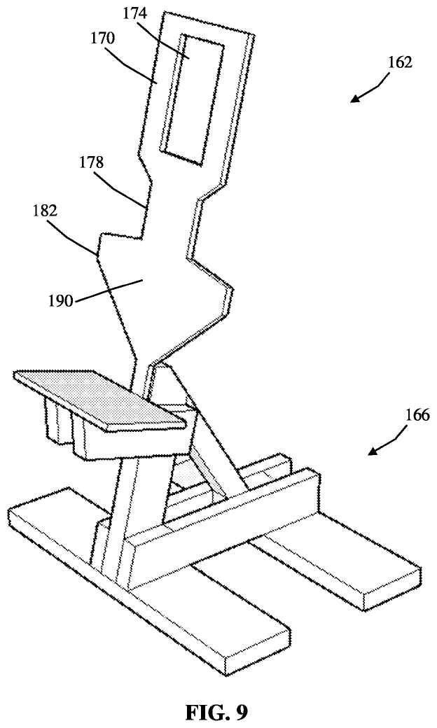

With reference to FIGS. 8, 9, and 10, one embodiment of the forward-rest board 162 with a test stand 166 is illustrated. The board 162 is similar to and interchangeable with the board 126. The forward-rest board 162 is sized for children between the ages of 1.5 and 7 years. In some embodiments, the total body lengths suitable for the forward-rest board 162 is within a range of 30 inches to 52 inches. In some embodiments, the total body length of the patient is less than approximately 60 inches tall.

With reference to FIG. 8, the board 162 includes an end portion 170 with an aperture 174, a narrow portion 178, and a flared portion 182 with wings 186. In the illustrated embodiment, the narrow portion 178 is positioned between the end portion 170 and the flared portion 182. A first surface 190 of the board 162 has a first dimension 194 in the end portion 170, and a second dimension 198 in the narrow portion 178. The second dimension 198 is smaller than the first dimension 194. The first surface 190 of the board 162 has a third dimension 202 in the flared portion 182. The third dimension 202 is larger than the first dimension 194.

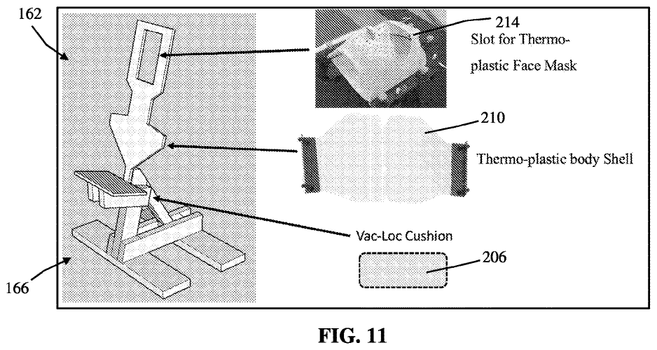

With reference to FIG. 11, the system further includes a vacuum formed bag 206 (e.g., a Vac-Loc bag or cushion). In some embodiments, the vacuum formed bag 206 is position on the seat portion 122 and formed to provide a customized seat contour for the patient. The vacuum formed bag 206 is used to anchor the patient's bottom (e.g., pelvic region) to the seat portion. The vertical position of the patient along the board will be adjusted by the total thickness of the vacuum-formed bag 206 underneath the patient.

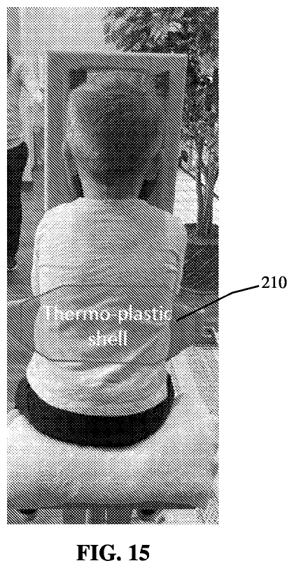

With continued reference to FIG. 11, the system further includes a shell 210 coupled to the board 162 and configured to support a lower back of a patient. See, for example, FIG. 15. In some embodiments, the shell 210 is a thermo plastic body shell. In some embodiments, two ends of the shell 210 are releasably connected to the wing portions 186 of the board 162. The board 162 provides a flat surface in the abdominal region that allows for attaching the thermoplastic body shell 210 around the back of the patient to hold the patient in a reproducible and comfortable position.

With continued reference to FIG. 11, the system further includes a face mask 214 for supporting and/or immobilizing a patient's head. In some embodiments, the aperture 174 in the end portion 170 of the board 162 selectively receive a portion of the face mask 214. In some embodiments, the face mask 214 is a thermos plastic face mask. The aperture 174 can accommodate a prone face mask system. In some embodiments, the face mask 214 is releasably secured to the board 162 at the aperture 174. The face mask 214 enables the patient to watch a movie during CT simulation and treatment. This renders the treatment (e.g., CSI treatment) technique compatible with the Stanford Avatar project (See Susie Hineker Communication/Papers). The face mask system will also allow for attaching a thermos plastic shell to the back of the patient's head to hold the entire head in position.

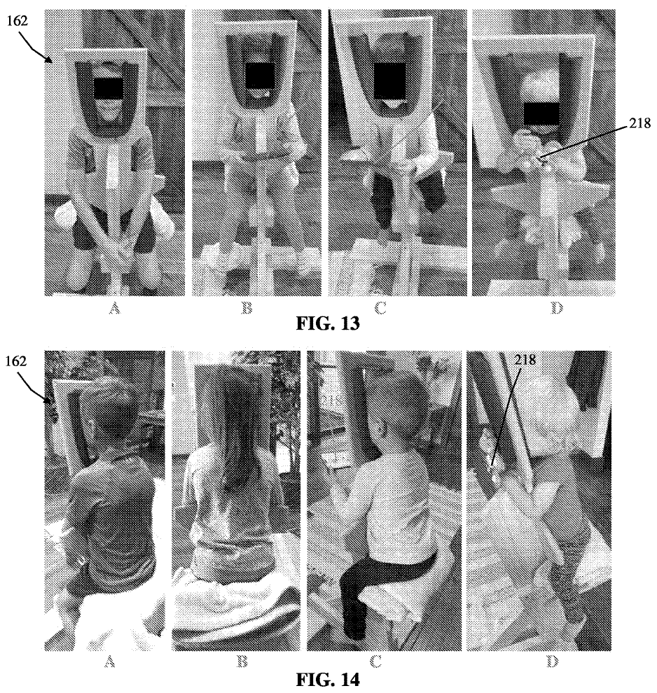

In some embodiments, the system includes an attention capturing component 218 configured to occupy or distract the patient while the patient is positioned on the board 162. In other words, the patient's face protrudes through the aperture 170 such that the patient can view or interact with an attention capturing component 218. In some embodiments, the attention capturing component 218 is visible by the patient when the patient face is inserted into the aperture 170 of the board 162. In other words, the patient can see the attention capturing component 218 through the aperture 170, and can interact or manipulate the attention capturing component 218 with their hands. In some embodiments, the attention capturing component is a video display or tablet computer (FIGS. 13, 14). In other embodiments, the attention capturing component is a toy such as a fidget spinner or other suitable manipulatable toy (FIGS. 13, 14). In some embodiments, a mounting bracket for the attention capturing component is coupled to the board.

In some embodiments, the system further includes arm and leg support systems to immobilize the arms and legs of the patient.

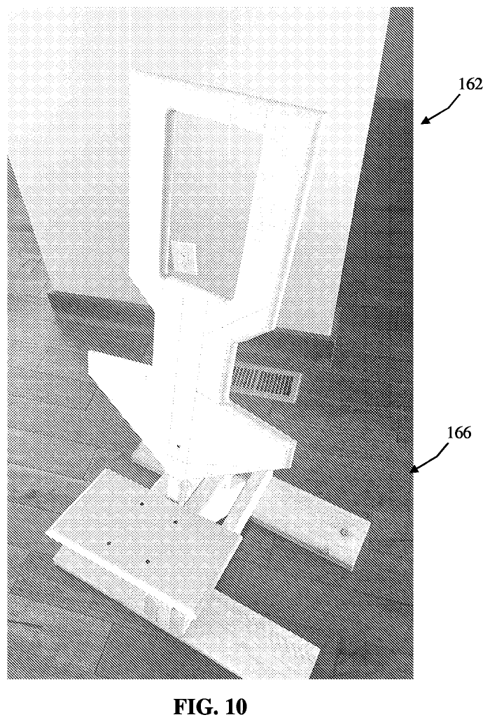

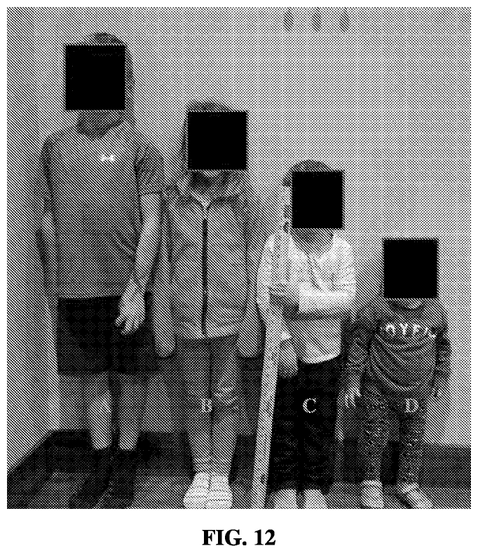

With reference to FIGS. 12-14, various sized example patients are shown supported by the board 162 and test stand 166 of FIG. 10. For reference, a meter stick is shown positioned with respect to the example patients in FIG. 12.

Finally, there is also a third category of pediatric patients that are shorter than the 5% Japanese female but cannot go through the treatment process without being sedated or anesthetized. In some embodiments, patients immobilized in the upright position using the systems detailed herein are administered anesthesia.

Although the disclosure herein refers to certain illustrated embodiments, it is to be understood that these embodiments are presented by way of example and not by way of limitation.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

### References

1. Yang J, et al. Advantages of simulating thoracic cancer patients in an upright position. Pract Radiat Oncol. 2014;4:e53-e58.2.
2. McCarroll, R. E., et al (2017), Reproducibility of patient setup in the seated treatment position: A novel treatment chair design. J Appl Clin Med Phys, 18: 223-229. doi:10.1002/acm2.12024
3. Thomas Rockwell Mackie, et al “Is upright radiotherapy medically and financially better?”, AIP Conference Proceedings 2348, 020002 (2021) https://doi.org/10.1063/5.0051770
4. S. Boisbouvier, et al Upright patient positioning for pelvic radiotherapy treatments, Technical Innovations & Patient Support in Radiation Oncology, Volume 24, 2022, Pages 124-130, ISSN 2405-6324, https://doi.org/10.1016/j.tipsro.2022.11.003.

What is claimed is:

1. A patient support system comprising:
a base defining a center axis;
a seat portion coupled to the base;
a board coupled to the base; the board includes a first surface facing towards the center axis and a second surface opposite the first surface;
wherein the first surface of the board is configured to engage a front of a patient.

2. The system of claim 1, wherein the board includes an aperture configured to receive at least a portion of a head of the patient.

3. The system of claim 2, wherein the aperture is positioned in an end portion of the board.

4. The system of claim 1, wherein the board includes a first wing portion configured to at least partially support a first arm of the patient, and wherein the board includes a second wing portion configured to at least partially support a second arm of the patient.

5. The system of claim 1, wherein an angle is defined between the board and the center axis, and wherein the angle is within a range of 5 degrees to 45 degrees.

6. The system of claim 5, wherein the angle is adjustable.

7. The system of claim 1, wherein the first surface of the board has a first dimension in an end portion, and a second dimension in a narrow portion, the second dimension smaller than the first dimension.

8. The system of claim 7, wherein the end portion includes an aperture.

9. The system of claim 8, wherein the first surface of the board has a third dimension in a flared portion, the third dimension larger than the first dimension.

10. The system of claim 9, wherein the narrow portion is positioned between the end portion and the flared portion.

11. The system of claim 1, wherein the base is rotatable about the center axis.

12. The system of claim 1, wherein the base is movable along the center axis.

13. The system of claim 1, wherein the center axis is vertical.

14. The system of claim 1, further comprising a vacuum-formed bag.

15. The system of claim 14, wherein the vacuum formed bag is positioned on the seat portion.

16. The system of claim 1, further comprising a shell coupled to the board and configured to support a lower back of a patient.

17. The system of claim 1, further comprising an attention capturing component.

18. The system of claim 17, wherein the attention capturing component is a video display.

19. The system of claim 18, wherein the attention capturing component is a toy.

20. The system of claim 1, wherein the patient is less than 60 inches tall.

21. A heel booster including a bottom surface including a notch configured to at least partially receive a heel support of an upright patient positioning system, the heel booster further includes an elevated platform, a heel stop extending from the elevated platform, and a roller extending from the bottom surface.

22. A patient support system comprising:
a base defining a center axis;
a pedestal coupled to the base; and
a support pivotably coupled to the pedestal about a pivot axis;
wherein the support includes a lower portion, an upper portion, and an arcuate connection portion between the lower portion and the upper portion.

23. The patient support system of claim 22, wherein the pivot axis is orthogonal to the center axis.

24. The patient support system of claim 22, wherein the support further includes a head portion extending from the upper portion and configured to support a head of a patient.

25. The patient support system of claim 22, further including a shin stop coupled to the lower portion and configured to support a shin of a patient.
